(19) United States
(12) Patent Application Publication
(10) Pub. No.: US 2016/0004644 A1
(43) Pub. Date: Jan. 7, 2016

(54) Storage Controller and Method for Managing Modified Data Flush Operations From a Cache

(71) Applicant: LSI Corporation, San Jose, CA (US)

(72) Inventors: Sumanesh Samanta, Bangalore (IN); Mark Ish, Sandy Springs, GA (US); Suagata Das Purkayastha, Bangalore (IN)

(21) Appl. No.: 14/322,890

(22) Filed: Jul. 2, 2014

(51) Int. Cl. G06F 12/08

(52) U.S. Cl. CPC G06F 12/0891; G06F 2212/1016; G06F 2212/1056; G06F 2212/152; G06F 2212/202; G06F 2212/21; G06F 2212/222; G06F 2212/262; G06F 2212/281; G06F 2212/311; G06F 2212/69

(57) ABSTRACT

A storage controller maintaining a cache manages modified data flush operations. A set-associative map or relationship between individual cache lines in the cache and a corresponding portion of the host managed or source data store is generated in such a way that a quotient can be used to identify modified data in the cache in the order of the source data's logical block addresses. The storage controller uses a collision bitmap, a dirty bit map and a flush table when flushing data from the cache. The storage controller selects a quotient and identifies modified cache lines in the cache identified by the quotient. As long as the quotient remains the same, the storage controller flushes or transfers the modified cache lines to the data store. Otherwise, when the quotient is not the same, the data in the cache is skipped. A linked list is used to traverse skipped cache lines.

### TECHNICAL FIELD

The invention relates generally to data storage systems and, more specifically, to data storage systems employing a data cache.

### BACKGROUND

Some conventional computing systems employ a non-volatile memory device as a block or file level storage alternative for slower data storage devices to improve performance of the computing system and/or applications executed by the computing system. In this respect, because input/output (I/O) operations can be performed significantly faster to some non-volatile memory devices (hereinafter a “cache device” for simplicity) than from or to a slower storage device (e.g., a magnetic hard disk drive), use of the cache device provides opportunities to significantly improve the rate of I/O operations.

For example, in the system illustrated in FIG. 1, a data storage manager 10 controls a storage array 12 in a manner that enables reliable data storage. A host (computer) system 14 stores data in and retrieves data from storage array 12 via data storage manager 10. That is, a processor 16, operating in accordance with an application program or APP 18, issues requests for writing data to and reading data from storage array 12. Although for purposes of clarity host system 14 and data storage manager 10 are depicted in FIG. 1 as separate elements, it is common for a data storage manager 10 to be physically embodied as a card that plugs into a motherboard or backplane of such a host system 14.

Such systems may cache data based on the frequency of access to certain data stored in the data storage devices 24, 26, 28 and 30 of storage array 12. This cached or “hot” data, e.g., element B, is stored in a cache memory module 21, which can be a flash-based memory device. The element B can be identified at a block level or file level. Thereafter, requests issued by applications, such as APP 18, for the “hot” data are serviced by the cache memory module 21, rather than the storage array 12. Such conventional data caching systems are scalable and limited only by the capacity of the cache memory module 21.

A redundant array of inexpensive (or independent) disks (RAID) is a common type of data storage system that addresses the reliability by enabling recovery from the failure of one or more storage devices. The RAID processing system 20 includes a processor 32 and a memory 34. The RAID processing system 20 in accordance with a RAID storage scheme distributes data blocks across storage devices 24, 26, 28 and 30. Distributing logically sequential data blocks across multiple storage devices is known as striping. Parity information for the data blocks distributed among storage devices 24, 26, 28 and 30 in the form of a stripe is stored along with that data as part of the same stripe. For example, RAID processing system 20 can distribute or stripe logically sequential data blocks A, B and C across corresponding storage areas in storage devices 24, 26 and 28, respectively, and then compute parity information for data blocks A, B and C and store the resulting parity information P_ABC in another corresponding storage area in storage device 30.

A processor 32 in RAID processing system 20 is responsible for computing the parity information. Processing system 20 includes some amount of fast local memory 34, such as double data rate synchronous dynamic random access memory (DDR SDRAM) that processor 32 utilizes in the parity computation. To compute the parity in the foregoing example, processor 32 reads data blocks A, B and C from storage devices 24, 26 and 28, respectively, into local memory 34 and then performs an exclusive disjunction operation, commonly referred to as an Exclusive-Or (XOR), on data blocks A, B and C in local memory 34. Processor 32 then stores the computed parity P_ABC in data storage device 30 in the same stripe in which data blocks A, B and C are stored in data storage devices 24, 26 and 28, respectively. In the illustrated embodiment, the RAID processing system 20 evenly distributes or rotates the computed parity for the stripes in the storage array 12.

It is known to incorporate data caching in a RAID-based storage system. In the system illustrated in FIG. 1, data storage manager 10 caches data in units of blocks in accordance with cache logic 36. The cached blocks are often referred to as read cache blocks (RCBs) and write cache blocks (WCBs). The WCBs comprise data that host system 14 sends to the data storage manager 10 as part of requests to store the data in storage array 12. In response to such a write request from host system 14, data storage manager 10 caches or temporarily stores a WCB in one or more cache memory modules 21, then returns an acknowledgement message to host system 14. At some later point in time, data storage manager 10 transfers the cached WCB (typically along with other previously cached WCBs) to storage array 12. The RCBs comprise data that data storage manager 10 has frequently read from storage array 12 in response to read requests from host system 14. Caching frequently requested data is more efficient than reading it from storage array 12 each time host system 14 requests it, since cache memory modules 21 are of a type of memory, such as flash-based memory, that can be accessed much faster than the type of memory (e.g., disk drive) that data storage array 12 uses. The described movement of cached data and computed parity information is indicated in a general manner in broken lines in FIG. 1.

Flash-based memory offers several advantages over magnetic hard disks. These advantages include lower access latency, lower power consumption, lack of noise, and higher robustness to environments with vibration and temperature variation. Flash-based memory devices have been deployed as a replacement for magnetic hard disk drives in a permanent storage role or in supplementary roles such as caches.

Flash-based memory is a unique memory technology due to the sensitivity of reliability and performance to write traffic. A flash page (the smallest division of addressable data for read/write operations) must be erased before data can be written. Erases occur at the granularity of blocks, which contain multiple pages. Only whole blocks can be erased. Furthermore, blocks become unreliable after some number of erase operations. The erase before write property of flash-based memory necessitates out-of-place updates to prevent the relatively high latency of erase operations from affecting the performance of write operations. The out-of-place updates create invalid pages. The data in the invalid pages are relocated to new locations with surrounding invalid data so that the resulting block can be erased. This process is commonly referred to as garbage collection. To achieve the objective, valid data is often moved to a new block so that a block with some invalid pages can be erased. The write operations associated with the move are not writes that are performed as a direct result of a write command from the host system and are the source for what is commonly called write amplification. As indicated above, flash-based memories have a limited number of erase and write cycles. Accordingly, it is desirable to limit these operations.

In addition, as data is written to a flash-based memory it is generally distributed about the entirety of the blocks of the memory device. Otherwise, if data was always written to the same blocks, the more frequently used blocks would reach the end of life due to write cycles before less frequently used blocks in the device. Writing data repeatedly to the same blocks would result in a loss of available storage capacity over time. Consequently, it is important to use blocks evenly so that each block is worn or used at the same rate throughout the life of the drive. Accordingly, wear leveling or the act of distributing data across the available storage capacity of the memory device generally is associated with garbage collection.

When a cache includes frequently used data (i.e., data that is frequently accessed by the host system) data that is modified by an application program such as APP 18 while the data is in the cache must be flushed or transferred at a desired time to the storage array 12. A flush operation that writes the modified data to the storage array 12 in the order of the logical block addresses is considered efficient and desirable.

Conventional cache management systems deploy data structures such as an Adelson-Velskii and Landis (AVL) tree or buckets and corresponding methods to identify the modified data in a cache based on the logical block address of the corresponding location in the host controlled storage volume.

### SUMMARY

Embodiments of a storage controller and a method for managing modified or “dirty” data flush operations from a cache are illustrated and described in exemplary embodiments.

In an example embodiment, a storage controller includes interfaces that communicate data and commands to a host system and a data store respectively. The storage controller further includes a processing system communicatively coupled to the respective interfaces. The processing system includes a processor and a memory. The processing system is communicatively coupled to a cache. The memory includes cache management logic responsive to a set-associative cache coupled to the processor that when executed by the processor manages a collision bit map, a dirty bit map, and a flush table for respective portions of the cache. The separate portions of the cache are defined by a corresponding quotient. The cache management logic, when executed by the processor flushes or transfers modified data from the quotient identified portions of the cache to the data store in accordance with a sequence of logical block addresses as defined by the host system.

In another exemplary embodiment, a method for managing modified data flush operations from a cache is disclosed. The method includes the steps of defining a relationship between a cache line in a data store exposed to a host system and a location identifier associated with an instance of the cache line, the relationship responsive to a variable and a constant, maintaining a set of bitmaps that identify cache lines that include modified data, identifying a quotient responsive to the variable and the constant, using the quotient to flush a first associated cache line with modified data, consulting the set of bitmaps to identify a next subsequent cache line that includes modified data, verifying that a present quotient corresponds to a source logical disk for a present cache line, when the present quotient corresponds to the source logical disk, flushing the present cache line, otherwise, when the present quotient does not correspond to the source logical disk, recording an identifier for the present cache line, incrementing a cache line index and repeating the verifying, flushing and incrementing steps.

### BRIEF DESCRIPTION OF THE DRAWINGS

FIG. 1 is a block diagram illustrating a conventional data storage manager coupled to a host computer and a storage system.

FIG. 2 is a block diagram illustrating an improved storage controller in accordance with an exemplary embodiment.

FIG. 3A is a schematic illustration of cache line mapping between a source volume and a cache.

FIG. 3B is a schematic illustration of metadata structures as associated with the cache lines of the cache of FIG. 3B.

FIG. 4 is a schematic illustration of associative functions that define a first mapping to transfer data into the cache and a reverse mapping to return data to the source volume.

FIG. 5 is a schematic illustration of an embodiment of a flush table used by the storage controller of FIG. 2.

FIG. 6 is a schematic illustration of an embodiment of a link table used by the storage controller of FIG. 2.

FIG. 7 is a schematic illustration of an embodiment of a multiple-level modified or dirty data bit map of FIG. 2.

FIG. 8 is a flow diagram illustrating an embodiment of a method for managing modified data flush operations from a cache to a source volume.

FIGS. 9A and 9B include a flow diagram illustrating another embodiment of a method for managing modified data flush operations from a cache.

### DETAILED DESCRIPTION OF AN ILLUSTRATIVE EMBODIMENT

To increase cache availability and performance and to conserve the energy and processing time consumed in using and maintaining the described conventional data structures and methods, it is desired to eliminate and or replace the same.

In an exemplary embodiment, a flash-based cache store is sub-divided into 64 KByte segments. An identified block of 64 KByte of storage capacity in a source “disk” maps to a fixed address or location in the cache store. A first mathematical formula or base function is used to determine a fixed or base location in the cache as a function of a constant, a logical disk index and a cache line index. The base location is used by the storage controller to store data when the base location is not already storing data or is unused. For a given source (i.e. a host managed store), only a few 64 KByte storage blocks or segments can map to a given base location or address in the cache. The constant ensures a pseudo random distribution among source managed data volumes as determined by the mathematical formula. A second mathematical formula or first jump function identifies a first jump or offset location from the base location. The first jump location and any of the next L contiguous addresses in the cache will be used if the base location is not available. A third mathematical formula or second jump function identifies a second jump or offset location from the base location. The second jump location is different from the first jump location. The second jump location and any of the next L contiguous addresses in the cache will be used if both the base location and the first jump location with its L contiguous addresses are all unavailable for storing a cache line. When L is the integer 8, the first, second and third functions or mathematical formulas define a 17-way set-associative cache.

When a host I/O is received, it will first be checked if it is a cache “hit” in one of the 17 cache addresses. A collision bitmap will be created and maintained in metadata for identifying where data is present or located in the cache. That is, a select logical value in a specific location within the collision bitmap identifies when data is stored at a particular address or location in the cache. When data is not present in the cache, the collision bit map includes the opposed logical value to the select logical value and such a condition is representative of a cache “miss.” When the I/O operation or request is logged or recorded as a cache “miss”, then a virtual window is allocated to support the I/O request and the cache is bypassed. Once a host I/O is identified by the storage controller as meeting the appropriate criteria to enter the cache, i.e., the data associated therewith has become “hot,” then a free cache line address is allocated to the I/O using one of the three mathematical formulas as may be required under present cache storage circumstances and the data from the source segment is inserted or stored in the cache.

While the “hot” or most frequently accessed data is in the cache and the cache is being used to support host system, the host system from time to time may change the data while it is present in the cache. This modified data or “dirty” data is periodically flushed or transferred to the corresponding segments in the source managed data store.

An improved storage controller and method for managing modified data flushes or transfers from a cache to a storage array exploit a characteristic of a set-associative map. A given quotient establishes a relationship between data portions in the host or source managed storage volume and corresponding portions of a cache store. A modified or “dirty” bit map and a flush table are used along with the quotient and a set of equations that define the set-associative map to traverse the cache in the order of the source storage volume defined logical block addresses. When modified data is desired to be transferred to the source managed storage volume, the storage controller identifies a quotient and uses the quotient to review the corresponding portions of the cache identified by the quotient in accordance with the set associative mapping when searching for modified data. The modified data in the cache locations identified by the same quotient are flushed or transferred to the source managed storage. The modified data in the cache are identified using a multiple-level “dirty” or modified data bit map. While making passes over the cache, a link table including first and second linked lists is used to optimize the search for modified or dirty cache lines in a subsequent pass through the cache. Thereafter, the quotient is modified and the process repeats for the different quotient.

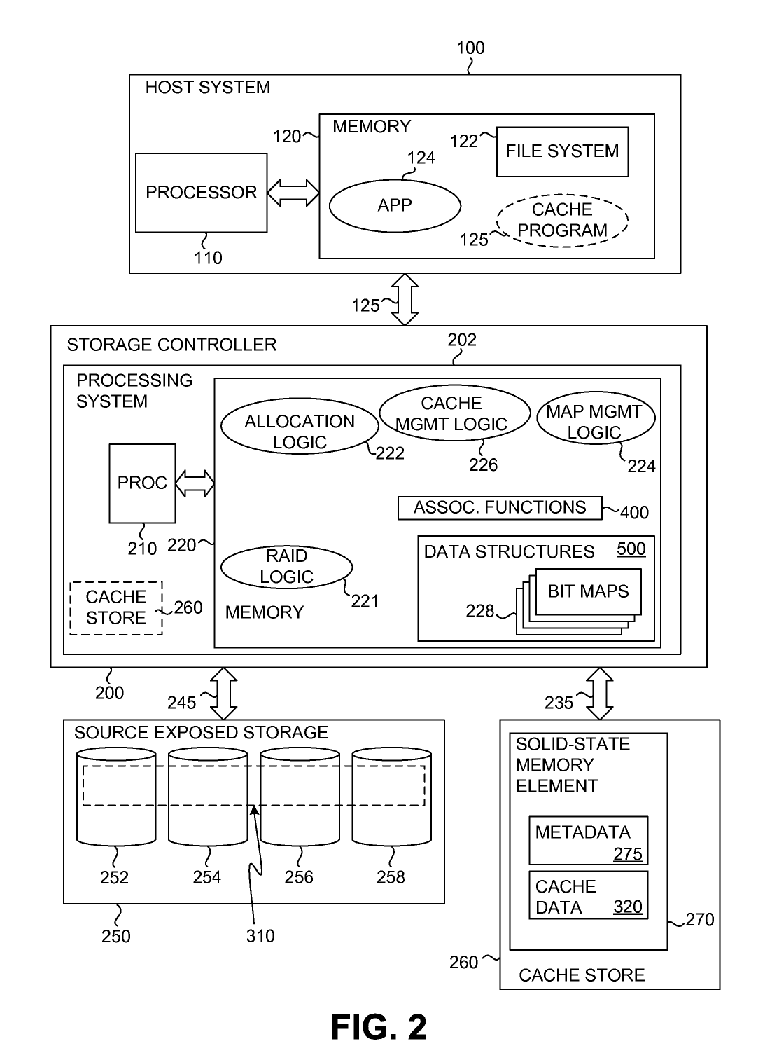

As illustrated in FIG. 2, in an illustrative or exemplary embodiment, host system 100 is coupled by way of a storage controller 200 to source exposed storage 250 and a cache store 260. The host system 100 communicates data and commands with the storage controller 200 over bus 125. The storage controller 200 communicates data and commands with the source exposed storage 250 over bus 245 and communicates with the cache store 260 over bus 235. In an example embodiment, the bus 125 is a peripheral component interconnect express (PCIe) compliant interface.

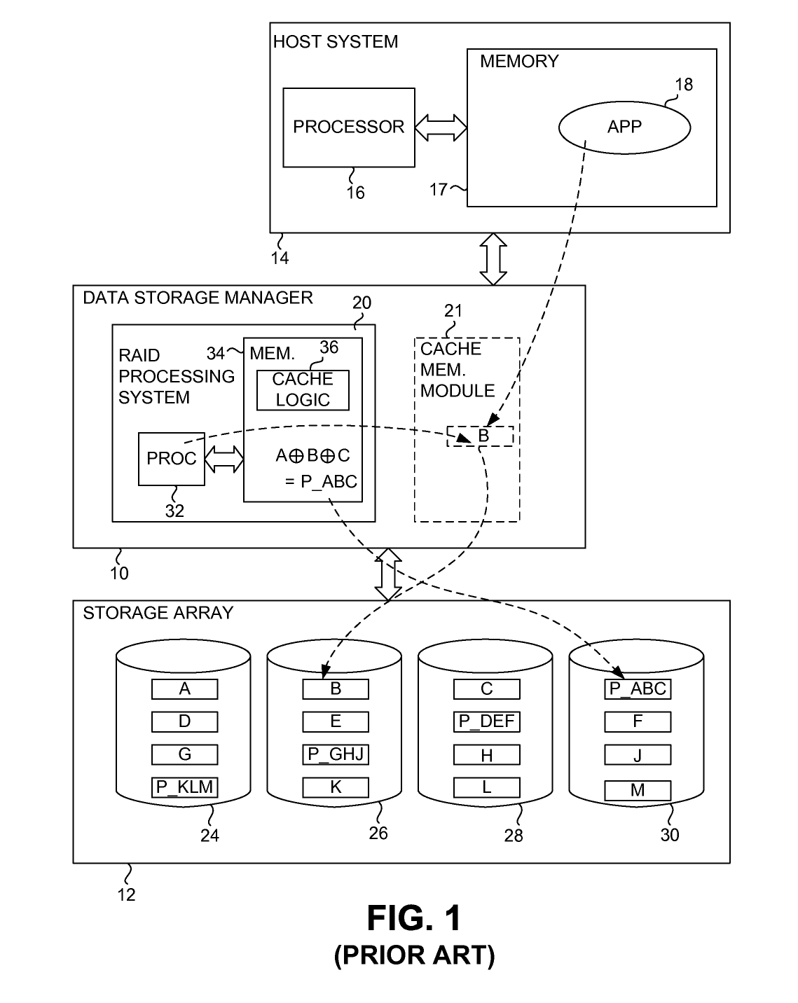

The source exposed storage 250 can be a direct attached storage (DAS) or a storage area network (SAN). In these embodiments, the source exposed storage 250 includes multiple data storage devices, such as those described in association with the storage array 12 (FIG. 1). When the source exposed storage 250 is a DAS, the bus 245 can be implemented using one or more advanced technology attachment (ATA), serial advanced technology attachment (SATA), external serial advanced technology attachment (eSATA), small computer system interface (SCSI), serial attached SCSI (SAS) or Fibre Channel compliant interfaces.

In an alternative arrangement, the source exposed storage 250 can be a network attached storage (NAS) array. In such an embodiment, the source exposed storage 250 includes multiple data storage devices, such as those described in association with the storage array 12 (FIG. 1). In the illustrated embodiment, the source exposed storage 250 includes physical disk drive 252, physical disk drive 254, physical disk drive 256 and physical disk drive 258. In alternative arrangements, storage arrays having less than four or more than four physical storage devices are contemplated. When the source exposed storage 250 is a NAS, the bus 245 can be implemented over an Ethernet connection, which can be wired or wireless. In such arrangements, the storage controller 200 and source exposed storage 250 may communicate with one another using one or more of hypertext mark-up language (HTML), file transfer protocol (FTP), secure file transfer protocol (SFTP), Web-based distributed authoring and versioning (Webdav) or other interface protocols.

Host system 100 stores data in and retrieves data from the source exposed storage 250. That is, a processor 110 in host system 100, operating in accordance with an application program 124 or similar software, issues requests for reading data from and writing data to source exposed storage 250. In addition to the application program 124, memory 120 further includes a file system 122 for managing data files and programs. As indicated in FIG. 2, the memory 120 may include a cache program 125 (shown in broken line) that when executed by the processor 110 is arranged to identify the frequency with which programs, files or other data are being used by the host system 100. Once such items cross a threshold frequency they are identified as “hot” items that should be stored in a cache such as cache store 260. The cache program 125 is shown in broken line in FIG. 2 as the functions associated with identifying, storing, maintaining, etc. “hot” data in a cache are preferably enabled within the processing system 202 of the storage controller 200. When so arranged, the logic and executable instructions that enable the cache store 260 may be integrated in the cache management logic 226 stored in memory 220.

Although application program 124 is depicted in a conceptual manner as stored in or residing in a memory 120, persons of skill in the art can appreciate that such software may take the form of multiple modules, segments, programs, files, etc., which are loaded into memory 120 on an as-needed basis in accordance with conventional computing principles. Similarly, although memory 120 is depicted as a single element for purposes of clarity, memory 120 can comprise multiple elements. Likewise, although processor 110 is depicted as a single element for purposes of clarity, processor 110 can comprise multiple elements.

In the illustrated embodiment, the storage controller 200 operates using RAID logic 221 to provide RAID protection, such as, for example, RAID-5 protection, by distributing data across multiple data storage devices, such as physical disk drive 252, physical disk drive 254, physical disk drive 256, and physical disk drive 258 in the source exposed storage 250. As indicated by a dashed line, a source or host data volume 310 is supported by storing data across respective portions of physical disk drive 252, physical disk drive 254, physical disk drive 256 and physical disk drive 258. Although in the exemplary embodiment storage devices 252, 254, 256 and 258 comprise physical disk drives (PDDs), the PDDs can be replaced by solid-state or flash memory modules. That the number of storage devices in source exposed storage 250 is four is intended merely as an example, and in other embodiments such a storage array can include any number of storage devices.

In alternative embodiments, the storage controller 200 can be configured to store programs, files or other information to a storage volume that uses one or more of the physical disk drives 252, 254, 256 and 258 in non-RAID data storage formats. However arranged the provided storage capacity is exposed to the host system 100 as a host managed storage resource.

The cache store 260 is arranged to improve performance of applications such as APP 124 by strategically caching the most frequently accessed data in the source exposed storage 250 in the cache store 260. Host system based software such as cache software 125 or cache management logic 226 stored in memory 220 of the storage controller 200 is designed to detect frequently accessed data items stored in source exposed storage 250 and store them in the cache store 260. The cache store 260 is supported by a solid-state memory element 270, which as described supports data transfers at a significantly higher rate than that of the source exposed storage 250. The solid-state memory element 270 is capable of storing cache data 320 and metadata 275.

A cache controller (not shown) of the solid-state memory element 270 communicates with storage controller 200 and thus host system 100 and source exposed storage 250 via bus 235. The bus 235 supports bi-directional data transfers to and from the solid-state memory element 270. The bus 235 may be implemented using synchronous or asynchronous interfaces. A source synchronous interface protocol similar to a DDR SRAM interface is capable of transferring data on both edges of a bi-directional strobe signal. When the solid-state memory element 270 includes not logical AND memory cell logic or NAND flash memory, the solid-state memory element 270 is controlled using a set of commands that may vary from device to device.

Although solid-state memory element 270 is depicted as a single element for purposes of clarity, the cache store 260 can comprise multiple such elements. In some embodiments, the solid-state memory element 270 can be physically embodied in an assembly that is pluggable into storage controller 200 or a motherboard or backplane (not shown) of host system 100 or in any other suitable structure. In one alternative embodiment, the cache store 260 may be integrated on a printed circuit or other assembly associated with the processing system 202 as indicated by broken line in FIG. 2.

Storage controller 200 includes a processing system 202 comprising a processor 210 and memory 220. Memory 220 can comprise, for example, synchronous dynamic random access memory (SDRAM). Although processor 210 and memory 220 are depicted as single elements for purposes of clarity, they can comprise multiple elements. Processing system 202 includes the following logic elements: RAID logic 221, allocation logic 222, cache management logic 226, and map management logic 224. In addition, the memory 220 will include a plurality of bit maps 228, a set of associative functions 400 and a host of other data structures 500 for monitoring and managing data transfers to and from the cache store 260.

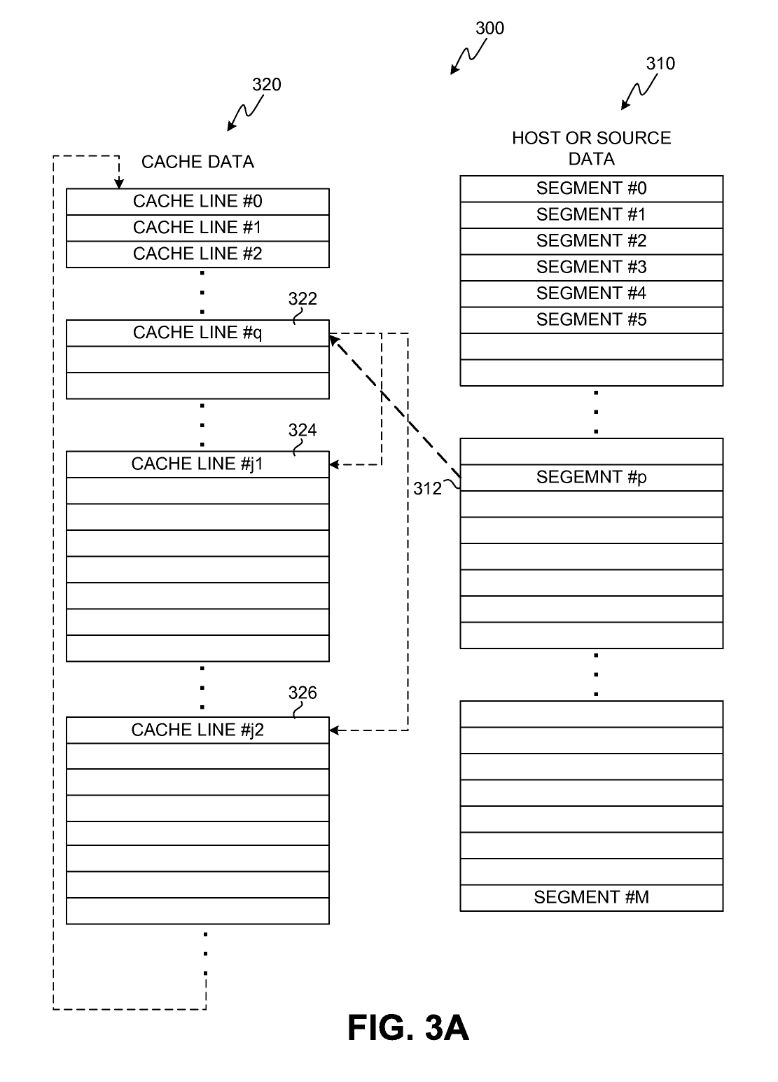

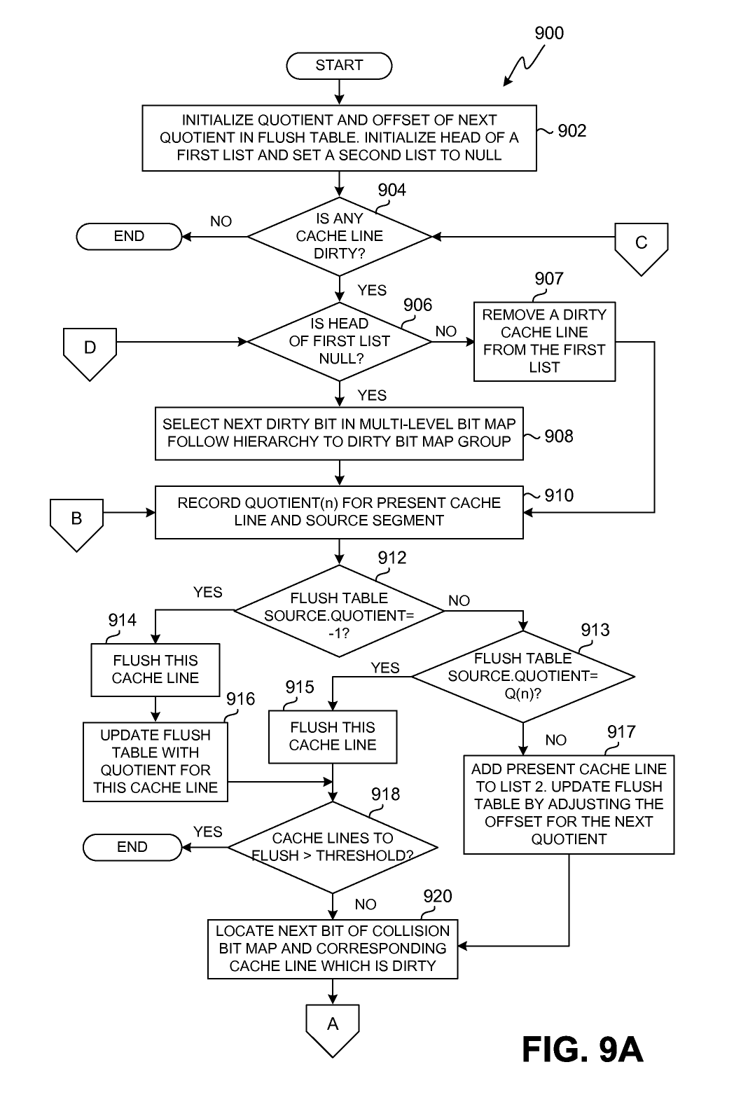

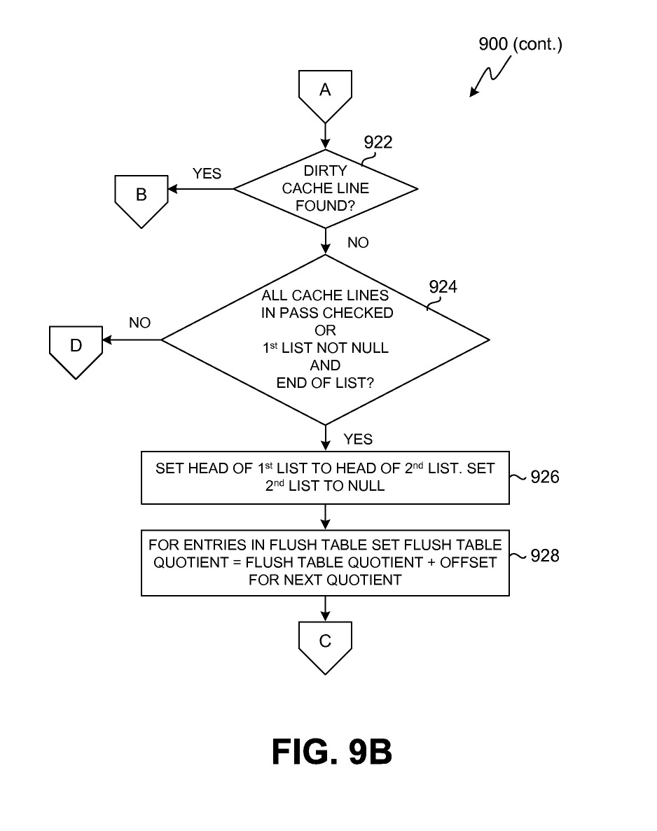

These logic elements or portions thereof together with the data structures 500 including the bit maps 228 and the associative functions 400 are used by the processing system 202 to enable the methods described below. Both direct and indirect mapping between a source data volume 310 and cache data 320, enabled by use of the associative functions 400, as executed by the processor 210, are described in association with the illustration in FIG. 3A. Data structures, including the various bit maps and their use are described in detail in association with the description of the illustration in FIGS. 3B, and 4-7. The architecture and operation of the cache management logic 226 is described in detail in association with the flow diagrams in FIGS. 8, 9A and 9B.

The term “logic” or “logic element” is broadly used herein to refer to control information, including, for example, instructions, and other logic that relates to the operation of storage controller 200 in controlling data transfers to and from the cache store 260. Furthermore, the term “logic” or “logic element” relates to the creation and manipulation of metadata or data structures 500. Note that although the above-referenced logic elements are depicted in a conceptual manner for purposes of clarity as being stored in or residing in memory 220, persons of skill in the art can appreciate that such logic elements may take the form of multiple pages, modules, segments, programs, files, instructions, etc., which can be loaded into memory 220 on an as-needed basis in accordance with conventional computing principles as well as in a manner described below with regard to caching or paging methods in the exemplary embodiment. Unless otherwise indicated, in other embodiments such logic elements or portions thereof can have any other suitable form, such as firmware or application-specific integrated circuit (ASIC) circuitry.

FIG. 3 is a schematic illustration of cache line mapping between host or source data 310 and cache data 320 within the cache store 260 of FIG. 2. The host or source data is sub-divided into M segments, where M is an integer. Each of the segments in the source data 310 has the same storage capacity. Once data stored within a data segment becomes “hot” then a free or unused cache line in the cache data 320 is allocated to store the data segment. Once stored in the cache store 260, I/O requests from the host system 100 (FIG. 2) for the “hot” data are serviced by the storage controller 200 by accessing an appropriate cache line in the cache data 320.

As illustrated in FIG. 3A, the cache lines in cache data 320 each include 64 Kbytes. A given source segment “p” 312 will map to any of a select number of cache line addresses or locations in the cache data 320.

In an example embodiment, a first mathematical function or base equation defines a first or base location 322 in the cache data 320. The first mathematical function or base equation is a function of a product of a constant and a logical disk index. This product is summed with the index or position in sequence in the sub-divided source data 310 to generate a dividend for a modulo n division. The result of the modulo n division (also referred to as a remainder) identifies a base index or position in the cache data 320.

An example first or base equation can be expressed as:

q=(constant*LD Index+p)% n Eq. 1

where, the constant (e.g., 0x100000) ensures the probability of cache lines from a different source 310 (as defined by a LD Index) mapping to the same base location is unlikely, LD Index is an identifier of a logical disk under the control of the host system 100, and n is an integer equal to the number of cache lines in the cache data 320.

A second mathematical function or first jump equation defines a first jump location 324 in the cache data 320 that is offset from the base location 322. The second mathematical function or first jump equation is a function of the remainder from Eq. 1. That is, the remainder from Eq. 1 is bit wise logically ANDed with ‘0x07.’ The result of this first operation is shifted to the left by three bits. The result of the second operation is added with the result of the division of the integer n by ‘4’. The result of these additional operations generates a second dividend for a modulo n division. The result of the second modulo n division identifies a first jump position j1 (a jump location 324) in the cache data 320. The example first jump equation can be expressed as:

P j1=((n/4)+((q&0x07)<<3))% n Eq. 2

where, Eq. 2 defines eight cache lines starting at j1. These locations will wrap to the start of the cache locations if the end of the available cache locations is reached.

A third mathematical function or second jump equation defines a second jump location 326 in the cache data 320 that is offset from the base location 322. The third mathematical function or second jump equation is a function of the remainder from Eq. 1. That is, the remainder from Eq. 1 is bit wise logically ANDed with ‘0x07’. The result of this first operation is shifted to the left by three bits. The result of the second operation is added with the result of the product of the integer n and the ratio of 3/4. The result of these additional operations generates a third dividend for a modulo n division. The result of the third modulo n division identifies a second jump position j2 (i.e., a second jump location 326) in the cache data 320. The example second jump equation can be expressed as:

j2=((n*3/4)+((q&0x07)<<3))% n Eq. 3

where, Eq. 3 defines eight cache lines starting at j2. These locations will wrap to the start of the cache locations if the end of the available cache locations is reached. The base equation, first jump equation and second jump equation define (i.e., Eq. 1, Eq. 2 and Eq. 3) a 17-way set-associative cache.

Alternative arrangements are contemplated. In an example alternative embodiment, a 16-way set associative cache is defined using a two-step process. In a first step, a base location is determined in the same manner as in Eq.1. In a second step, a coded base location q′ is determined as a function of the quotient determined in the first step. A given source segment can map to any of the 16 consecutive cache lines from this coded base location.

When a host I/O request is received, the host or source data index is used to generate the base location and/or one or both of the first and second jump locations as may be required.

However the set-associative mapping is defined, a related set of functions or equations are used to determine a reverse map. That is, given a cache line location q in the cache data 320, an equation or equations can be used to identify the corresponding data segment p in the source 310. The cache management logic 226 generates and maintains an imposter index or identifier that tracks or identifies the source segment identifier p. The imposter index includes a cache line mask, a Jump1 flag, a jump2 flag and a jump index. The cache line mask is the resultant (q & 0x07) value from Equation 2 or Equation 3. If the respective cache line was allocated directly after the mapping through Equation 1 then Jump1, Jump2, and jump index will be 0. However, if the respective cache line was allocated after Jump1 (i.e., from Equation 2) then Jump1 will be set to 1, Jump2 will be set to 0 and the jump index will be set to the value within the 8 consecutive slots where this cache line has been allocated. If the respective cache line was allocated after Jump2 (i.e., from Equation 3) then Jump2 will be set to 1, Jump1 to 0 and the jump index will be set to the value within the 8 consecutive slots where the cache line has been allocated.

The quotient together with the imposter index is used to identify the source segment which is currently mapped in this cache line in the cache data 320. Consider the cache line index in the cache store 320 is ‘q’. Then the corresponding source segment identifier ‘p’ is derived as:

p=(quotient*n+q)−constant*LD Index) Eq. 4

where, the constant is the same constant used in Eq. 1.

When the imposter index Jump1 sub-portion is set, then the corresponding source segment identifier ‘p’ is derived as:

p=((quotient*n+q−jump index−j1)−constant*LD Index) Eq. 5

where, j1 is derived from Eq. 2 and the constant is the same constant used in Eq. 1.

When the imposter index Jump2 sub-portion is set, then the corresponding source segment identifier ‘p’ is derived as:

p=((quotient*n+q−jump index−j2)−constant*LD Index) Eq. 6

where, j2 is derived from Eq. 3 and the constant is the same constant used in Eq. 1.

The corresponding locations in the cache data 320 are checked to determine if the cache data 320 already includes the source data to be cached. When this data of interest is present in the cache, a cache “HIT” condition exists. When the data of interest is not present in the cache as determined after review of the data in the locations defined by the described equations, a cache “MISS” condition exists. When a cache MISS occurs, a virtual window (not shown) is allocated by the allocation logic 222 and the cache data 320 is bypassed.

As indicated in FIG. 3B, a collision bit map 350, a dirty bit map 340 and a quotient store 330 are created and maintained along with additional metadata structures (not shown) by the cache management logic 226. The collision bit map 350 indicates which cache lines in an M-way set-associative cache (or which cache lines in an alternative set-associative cache) are used. When the collision bit map 350 is set to 0, the direct mapped cache line as indicated by Equation 1 is used. When a bit ‘t’ is set in the lower significant 8-bits of the collision bit map 350, the t-th cache line from the j1-th cache line, as indicated by Equation 2, is used. Otherwise, when a bit T is set in the upper significant 8-bits of the collision bit map 350, the t-th cache line from the j2-th cache line, as indicated by Equation 3, is used.

For example, as illustrated in FIG. 3B, collision bit map 350 includes a bit for each of the possible locations in the cache data 320 where cached data may be stored in conjunction with the equations used to define the set-associate cache. In the illustrated embodiment, a cache line “q” is in use as indicated by grey scale fill. In addition, eight contiguous cache lines continuing at the Jump 1 location (j1) 324 and another eight contiguous cache storage locations continuing at the Jump 2 location (j2) 326 are also in use. When a corresponding cache line in the cache data 320 is in use the map management logic 224 stores a logical 1 value in the corresponding location in the collision bit map 350. Accordingly, the collision bit map 350 indicates a logical 1 in each of the corresponding bits.

The dirty bit map 340 includes a bit for each of the storage locations in the cache data 320. In the illustrated embodiment a logical 1 value indicates that the data stored in the cache at the corresponding location has been modified while the data was in the cache.

The quotient store 330 includes a value that is used to specifically define each of the separate cache lines in the cache data 320. Although indicated schematically as a single block, it should be understood that the quotient will include multiple bits to separately define each of the cache lines in the cache data 320. In an example embodiment, the quotient may be calculated as Qt=(constant*LD Index+p)/n.

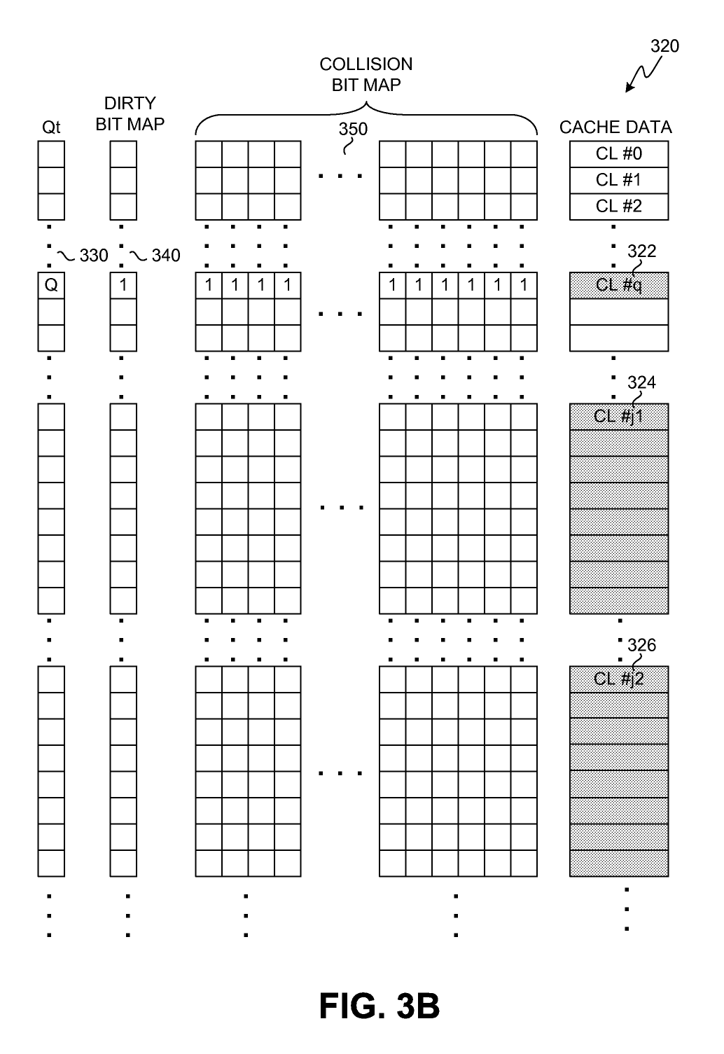

FIG. 4 schematically shows a set of associative functions 400. A first subset 412 includes three member equations or mathematical functions, the members of which may include Eq. 1 (also known as a base equation), Eq. 2 (also known as a first jump equation) and Eq. 3 (also known as a second jump equation.). The first subset 412, as further shown in FIG. 4, identify a mapping of a first location (i.e., a segment) in the source data 310 to a corresponding set of 17 locations in the cache data 320, as described above in association with FIG. 3A.

A second subset 414, like the first subset 412, includes three member equations or mathematical functions. However, the second subset 414 may include Eq. 4 (also known as a direct reverse equation or mapping), Eq. 5 (also known as first reverse jump equation or mapping) and Eq. 6 (also known as a second reverse jump equation or mapping). This second subset 414 of equations identifies relationships between the 17 locations in the cache data 320 and a corresponding location in the source data 310.

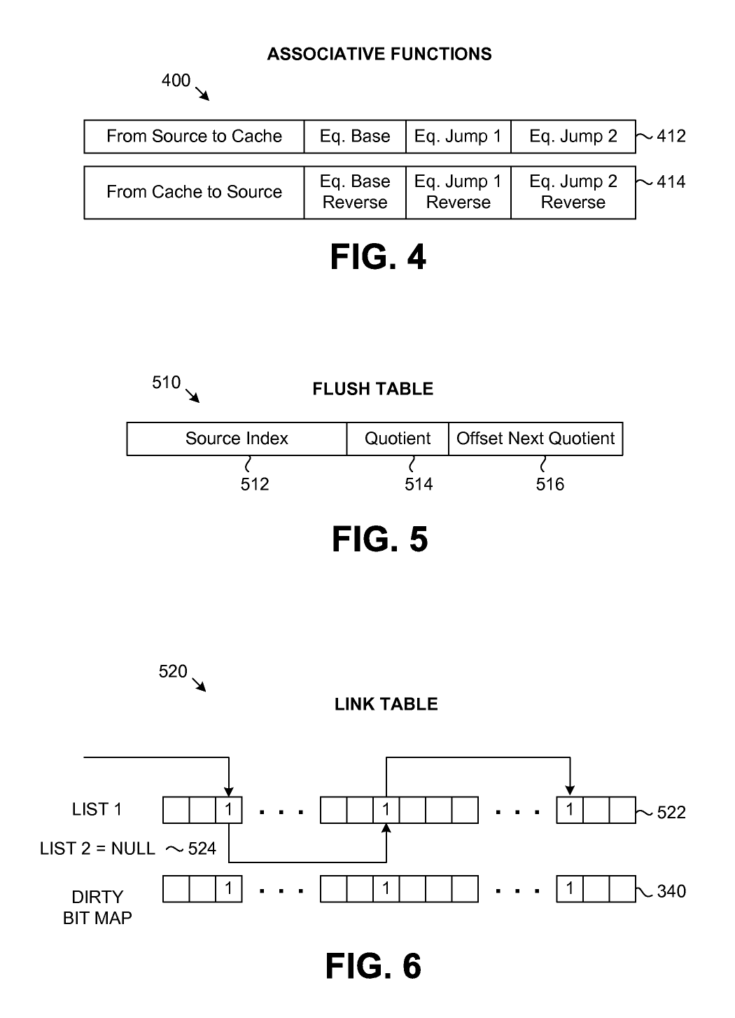

FIG. 5 schematically shows an example embodiment of a flush table 510. The flush table 510 includes a source index 512, a quotient 514 and an Offset for the next quotient to flush. The flush table 510 is used by the cache management logic 226 to efficiently manage transfers of modified or dirty data from the cache data 320 to the source data 310. Use of the flush table 510 and its components is described in further detail in association with the flow diagram illustrated in FIGS. 9A and 9B.

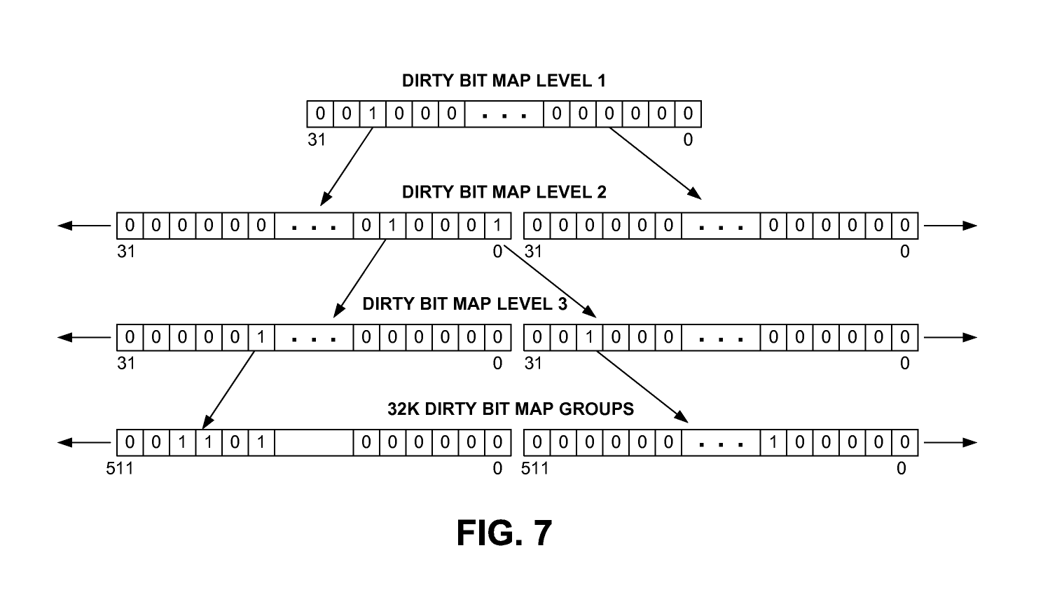

FIG. 6 schematically shows an example embodiment of a link table 520. The link table 520 includes a first list or List 1 522 and a second list or List 2 524. An example dirty bit map 340 is included in the illustration to show the relationship between the location of an identifier of modified or dirty information in a corresponding storage location in the cache data 320 and the link table 520. In this regard, the cache management logic 226 links the dirty or modified cache lines which get skipped during a flushing operation in a linked list. During a flushing operation, the cache line from the List 1 522 gets flushed. When the cache line in List 1 522 is skipped again it is temporarily added to List 2 524. At the end of a pass through the cache 320 the head of the List 1 522 is adjusted to point to the head of List 2 524 and before a next pass is started, List 2 is cleared or made null. Use of the link table 520 and the component linked lists is described in further detail in association with the flow diagram illustrated in FIGS. 9A and 9B.

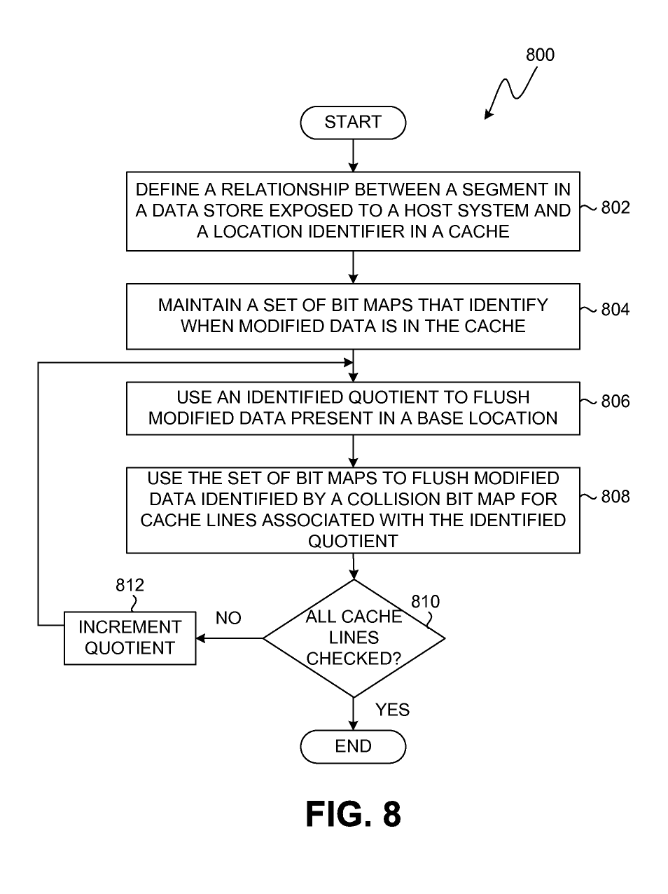

FIG. 7 is a schematic illustration of an embodiment of a multiple-level modified or dirty data bit map of FIG. 2. In the illustrated embodiment, the dirty bit map is sub-divided into 32K separately identifiable groups. For a cache store 260 with a 1 TB storage capacity, each of the 32K groups will include 512 bits. In alternative embodiments the cache store 260 may have less or more storage capacity and the number of bit groups may be larger or smaller than 32K.

In the example embodiment, the multi-level bit map includes first, second, and third levels. A 30^{th} bit is set in the level 1 dirty bit map when the 30^{th} group in the level 2 dirty bit map has a dirty bit set. Similarly, an nth bit is set in the level 2 dirty bit map when the nth group of the level 3 dirty bit map has a dirty bit set. Dirty bit map level 3 is accessed as 1024 integers of 4 bytes each. A bit “n” in level 3 is set when any bit from ‘n’*‘m’ to ‘n+1’*‘m’−‘1’ is set in a corresponding dirty bit map group, where ‘m’ is the size of the dirty bitmap group. Dirty bit map level 2 is accessed as 32 integers of 4 bytes each. A bit ‘n’ in dirtyLevel2 is set, if any bit from ‘n’*‘32’ to ‘n+1’*‘32’−‘1’ is set in dirty bit map level 3. Dirty bit map level 1 is accessed as one integer of 4 bytes. A bit ‘n’ in dirty bit map level 1 is set, if any bit from ‘n’*32 to ‘n+1’*32−1 is set in dirty bit map level 2.

For a given cache line ‘n’, the corresponding bits in dirty bit map level 1, dirty bit map level 2 and dirty bit map level 3 can be easily calculated as n>>19, n>>14 and n>>9, respectively (assuming 1 TB of total cache capacity). That is, for cache line “n” the corresponding bit in dirty bit map level 1 is found by a shift of ‘n’ to the right by 19 bits and will indicate whether the corresponding cache line ‘n’ includes modified data. Similarly for cache line “n” the corresponding bit in dirty bit map level 2 is found by a shift of ‘n’ to the right by fourteen bits and will indicate whether the cache line ‘n’ includes modified data. For cache line “n” the corresponding bit in dirty bit map level 3 is found by a shift of ‘n’ to the right by 9 bits and will indicate whether the cache line ‘n’ includes modified or dirty data.

When a cache line gets dirty, the corresponding bits in dirty bit map level 1, dirty bit map level 2 and dirty bit map level 3 are set. Similarly, when a cache line is flushed then it is checked if all the neighboring cache lines in the group are not-dirty then the corresponding bit in dirty bit map level 3 is cleared. Again if the bit cleared in dirty bit map level 3 makes the group of 32 bits cleared, then the corresponding bit in dirty bit map level 2 is cleared. This process is repeated until dirty bit map level 1.

The storage controller 200 is arranged to determine the first bit that is set to a logical 1 value in the dirty bit map level 1 and to traverse the multi-level dirty bit map to identify the dirty cache line. The quotient Qt for the modified cache line is recorded in the flush table 510 and the storage controller 200 flushes the identified cache line. The multi-level dirty map is consulted again to identify the next dirty or modified cache line in the cache 320. A check is performed if the cache line quotient is the same as the quotient stored in the flush table 510. If the quotient is different the cache line is skipped for this pass and the cache line is added to the list 2 524 by placing a logical 1 in the corresponding location in the link table 520. After all the dirty cache lines have been checked once, the storage controller 200 moves the list 2 524 to list 1 522 in the link table 520 and returns the list 2 524 to null. In addition, the quotients in the flush table 510 are modified based on the offset of the next quotient. On subsequent passes through the cache store 320, the storage controller 200 uses the list 1 522 to identify dirty cache lines rather than the multi-level dirty bit map. The flushing continues as long the quotient is the same as the quotient in the flush table of the corresponding source segment. Otherwise, the cache line is skipped. The storage controller 200 continues flushing cache lines until all dirty cache lines have been flushed or until a threshold number of cache lines that can be flushed simultaneously has been identified.

FIG. 8 is a flow diagram illustrating an embodiment of a method 800 for managing modified data flush operations from a cache to a source volume. The method 800 begins with block 802 where a relationship is defined between a segment in a data store exposed to a host system and a location identifier in a cache. In block 804 a set of bit maps are maintained to identify when modified data is present in the cache. In block 806 an identified quotient is used to flush data present in a base location. In block 808 the set of bit maps are used to flush modified data identified by a collision bit map for cache lines associated with the identified quotient. In decision bock 810 it is determined if all cache lines have been checked. When all cache lines have been checked the method for flushing data is terminated. Otherwise, the quotient is incremented as indicated in block 812 and the functions illustrated in blocks 806 through 810 are repeated as desired.

FIGS. 9A and 9B include a flow diagram illustrating another embodiment of a method 900 for managing modified data flush operations from a cache. The method 900 begins with block 902 where a flush table is initialized by setting each entry of quotient to −1 and each entry of the offset of the next quotient to a maximum interval, respectively. In addition, list 1 and list 2, the members of the link table are cleared or set to null. In decision block 904, the storage controller 200 checks the contents of the dirty bit map 340 to determine if any cache line in the cache data 320 has been modified while the corresponding data therein has been stored in the cache. When no cache line has been modified the method 900 terminates. Otherwise, the storage controller 200, as indicated in decision block 906, determines whether the head of the list 1 (the skipped list) is null.

When the head of the list 1 is not null, the storage controller 200 removes a dirty cache line from the list 1 and bypasses the multi-level bit map search in block 908. Otherwise, as indicated in block 908, when the head of the list 1 is null, the storage controller 200 selects the next dirty bit as identified in the dirty bit map groups by traversing the multi-level dirty bit map. That is, when a bit is set in the dirty bit map level 1, find the corresponding bit set in dirty bit map level 2, use the corresponding bit set in dirty bit map level 2 to find the corresponding bit in dirty bit map level 3, and use the corresponding bit set in dirty bit map level 3 to find the corresponding dirty bit in the dirty bit map group.

Upon completion of the search through the multi-level dirty bit maps in block 908, the storage controller 200 records a present quotient Qt and a related source segment identifier, as shown in block 910. As indicated in decision block 912, the storage controller 200 determines if the value of the source segment identifier in the flush table 510 is −1. When the source segment value in the flush table 510 is −1, the storage controller 200 flushes the present cache line as indicated in block 914. In block 916, the storage controller 200 updates the flush table with the quotient for the present cache line and as shown in decision block 918 determines if the number of cache lines identified for flush has crossed a threshold value. When the number of cache lines to flush has crossed the threshold the storage controller 200 terminates the method 900.

Otherwise, when the value of the source segment identifier is not −1 as determined in decision block 912, the storage controller 200 determines if the present quotient matches the quotient in the flush table in decision block 913. When the value in the flush table matches the present quotient the storage controller 200 flushes the cache line as indicated in block 915. Thereafter, as indicated in decision block 918, the storage controller 200 determines if the number of cache lines to flush has exceeded a threshold value. When the number of cache lines to flush exceeds the threshold value, the storage controller 200 terminates the method 900.

Otherwise, when the value in the flush table does not match the present quotient, the storage controller 200 bypasses the functions in block 915 and decision block 918, adds the present cache line to list 2 and updates the flush table by adjusting the offset for the next quotient, as shown in block 917. The adjustment of the offset for the next quotient in block 917 includes replacement by the smaller of the offset value presently in the flush table and the difference of the present quotient Qt and the quotient in the flush table.

Thereafter, as indicated in block 920, the storage controller 200 uses the collision bit map to identify the next cache line that has been modified while in the cache that should be flushed. As shown by off-page connector A processing continues with the decision block 922 (FIG. 9B) where the storage controller 200 determines if a dirty cache line is found. When a dirty cache line is found, as indicated by off-page connector B, the storage controller 200 returns to function associated with block 910 (FIG. 9A). Otherwise, when a dirty cache line is not found in decision block 922, the storage controller 200 checks if all cache lines have been checked or if the list 1 is not null and the end of list 1 has been reached, as indicated in decision block 924. When the result of the determination in decision block 924 is negative and as shown by off-page connector D, the storage controller 200 continues with the query of decision block 906 (FIG. 9A). When the result of the determination in decision block 924 is affirmative and as shown in block 926, the storage controller 200 sets the head of the list 1 to the head of list 2 and sets the list 2 to null. In addition, as indicated in block 928, for all entries in the flush table, the quotient is updated with the sum of the present quotient and the offset of the next quotient. As indicated by off-page connector C, the storage controller 200 continues with the query of decision block 904 (FIG. 9A). The storage controller 200 continues flushing the cache lines until all dirty cache lines have been flushed or the number of cache lines that can be flushed simultaneously has been exceeded.

It should be understood that the flow diagrams of FIGS. 8, 9A and 9B are intended only to be exemplary or illustrative of the logic underlying the described methods. Persons skilled in the art will understand that in various embodiments, data processing systems including cache processing systems or cache controllers can be programmed or configured in any of various ways to effect the described methods. The steps or acts described above can occur in any suitable order or sequence, including in parallel or asynchronously with each other. Steps or acts described above with regard to FIGS. 8, 9A and 9B can be combined with others or omitted in some embodiments. Although depicted for purposes of clarity in the form of a flow diagram in FIGS. 8, 9A and 9B, the underlying logic can be modularized or otherwise arranged in any suitable manner. Persons skilled in the art will readily be capable of programming or configuring suitable software or suitable logic, such as in the form of an application-specific integrated circuit (ASIC) or similar device or a combination of devices, to effect the above-described methods. Also, it should be understood that the combination of software instructions or similar logic and the local memory 220 or other memory in which such software instructions or similar logic is stored or embodied for execution by processor 210, comprises a “computer-readable medium” or “computer program product” as that term is used in the patent lexicon.

The claimed storage controller and methods have been illustrated and described with reference to one or more exemplary embodiments for the purpose of demonstrating principles and concepts. The claimed storage controller and methods are not limited to these embodiments. As will be understood by persons skilled in the art, in view of the description provided herein, many variations may be made to the embodiments described herein and all such variations are within the scope of the claimed storage controller and methods.

What is claimed is:

1. A method for managing modified data flush operations from a cache, the method comprising:
defining a relationship between a cache line in a data store exposed to a host system and a location identifier associated with an instance of the cache line, the relationship responsive to a variable and a constant;
maintaining a set of bitmaps that identify cache lines that include modified data;
identifying a quotient responsive to the variable and the constant;
using the quotient to flush a first associated cache line with modified data;
consulting the set of bitmaps to identify a next subsequent cache line that includes modified data;
verifying that a present quotient corresponds to a source logical disk for a present cache line,
when the present quotient corresponds to the source logical disk,
flushing the present cache line;
otherwise, recording an identifier for the present cache line;
incrementing a cache line index; and
repeating the verifying, flushing and incrementing.

2. The method of claim 1, further comprising:
comparing a number of cache lines flushed with a threshold;
when the number of cache lines flushed has reached the threshold, terminating the method.
otherwise,
repeating the incrementing and the verifying, flushing, comparing, and incrementing.

3. The method of claim 2, further comprising:
determining when the corresponding cache line includes modified data before the verifying; and
checking that all cache lines defined by the relationship have been processed or a first list is not null and the end of the first list is encountered,
when the result of the checking is affirmative,
pointing a head of a first list to a head of a second list;
for all entries set in a flush table, update the quotient; and
making the head of the second list null;
determining when there are remaining cache lines with modified data;
when the result of the determining when there are remaining cache lines with modified data is negative, terminating the method;
otherwise, when the result of the determining when there are remaining cache lines with modified data is affirmative,
determining when a head of a first list is null,
when the head of the first list is null,
performing a multi-level bit map analysis to check that neighboring cache lines in a group do not include modified data before repeating the verifying, flushing, comparing, and incrementing;
when the head of the first list is not null,
removing a cache line with modified data from the first list; and
repeating the verifying, flushing and incrementing.

4. The method of claim 1, wherein maintaining a set of bitmaps that identify cache lines that include modified data includes creating and populating hierarchically related bit maps.

5. The method of claim 4, wherein the hierarchically related bit maps are responsive to groups of bits that represent respective portions of the cache.

6. The method of claim 1, wherein consulting the set of bitmaps to identify a next subsequent cache line that includes modified data includes identifying the contents of a collision bit map.

7. The method of claim 6, wherein consulting the set of bitmaps to identify a next subsequent cache line that includes modified data includes a bit shift.

8. The method of claim 1, wherein incrementing the cache line index includes consulting a flush table that for each portion of the source virtual disk identifies a corresponding quotient and an offset for the next subsequent cache line.

9. The method of claim 1, wherein recording the identifier for the present cache line includes maintaining information in a data structure.

10. The method of claim 9, wherein the data structure is a flush table.

11. The method of claim 9, wherein the data structure identifies cache lines skipped while flushing.

12. The method of claim 9, wherein the data structure includes a first list and a second list, the first list identifying cache lines to be flushed, the second list being null.

13. The method of claim 12, wherein when a cache line in the first list is skipped again the first list is appended to the second list and a head of the first list is modified to point to a head of the second list.

14. The method of claim 13, further comprising:
removing the data from the second list.

15. A storage controller, comprising:
a first interface for communicating with a host system, the first interface communicating data and command signals with the host system;
a processor coupled to the interface by a bus;
a second interface coupled to the processor by the bus, the second interface communicating data with a set of data storage elements supporting a logical volume; and
a memory element coupled to the processor having stored therein cache management logic responsive to a set-associative cache coupled to the processor, the cache management logic arranged to maintain a collision bit map, a dirty bit map, and a flush table for respective elements of the cache as separately defined by a corresponding quotient, the cache management logic further arranged to flush modified data from the cache to the set of storage elements in accordance with the quotient in a sequence of logical block addresses as defined by the host system.

16. The storage controller of claim 15, wherein the dirty bit map includes a bit that identifies when a corresponding location in the cache includes data that has been modified since the data was stored in the cache.

17. The storage controller of claim 15, wherein the collision bit map includes “n” bits that identify when a corresponding location in the cache is in use.

18. The storage controller of claim 15, wherein the flush table includes a source index and an offset for a next subsequent quotient that ensures that cache lines flushed to a data volume supported by the set of storage elements are arranged in accordance with a logical block address.

19. The storage controller of claim 15, wherein the cache management logic is further arranged to maintain a linked list during a flush operation.

20. The storage controller of claim 15, wherein the dirty bit map is a multi-level hierarchical arranged bit map.
